(19) United States
(12) Patent Application Publication
(10) Pub. No.: US 2018/0008931 A1
(43) Pub. Date: Jan. 11, 2018

(54) ELECTRO-CATALYTIC HONEYCOMB FOR EXHAUST EMISSIONS CONTROL AND MANUFACTURING METHOD THEREOF

(71) Applicant: JM International Patent Company, Taipei (TW)

(72) Inventors: Ta-Jen Huang, Hsinchu (TW); Ta-Hsin HUANG, Kaohsiung (TW)

(21) Appl. No.: 15/619,808

(22) Filed: Jun. 12, 2017

(30) Foreign Application Priority Data
Jul. 5, 2016 (TW) 105121171

(51) Int. Cl. B01D 53/94; B01D 53/32; F01N 3/28

(52) U.S. Cl. CPC B01D 53/944; B01D 53/9454; F01N 3/281; B01D 53/326; Y02T 10/22; B01D 2255/806

(57) ABSTRACT

An electro-catalytic honeycomb for exhaust emissions control and manufacturing method thereof firstly provides a honeycomb structural body comprising a backbone, a solid-oxide layer, a cathode layer and an inner annular layer. The backbone is provided with an anode and gas channels. The anode is provided with an outer surface and an inner surface inside the gas channels. The solid-oxide layer is formed on the inner surface. The cathode layer is formed on the solid-oxide layer. The inner annular layer is allowed for encapsulating an annular end edge of the outer surface. Subsequently, a sealing body is provided over the inner annular layer. Then, the anode is reduced to a reducing environment. Finally, an encapsulation is provided over the honeycomb structural body to seal the outer surface and a sealing membrane of the sealing body is removed for passing a lean-burn exhaust through the gas channels.

### FIELD OF THE INVENTION

The present invention is related to a device for exhaust emissions control and manufacturing method thereof particularly to an electro-catalytic honeycomb for exhaust emissions control and manufacturing method thereof.

### BACKGROUND OF THE INVENTION

Exhaust leading to air pollution includes nitrogen oxides (NOₓ), sulfur oxides (SOₓ), carbon monoxide (CO), hydrocarbons (HCs), particulate matter (PM) and so on. In this connection, the capability of carbon monoxide to combine with hemoglobin to form carboxyhemoglobin (COHb) is 300 times higher than the capability of oxygen to combine with hemoglobin to form oxyhemoglobin (HbO₂). Therefore, a too high concentration of carbon monoxide would degrade the capability of hemoglobin to transport oxygen. Nitrogen oxides are mainly in the form of nitrogen monoxide (NO) and nitrogen dioxide (NO₂). Reaction of nitrogen oxides and hydrocarbons is induced by ultraviolet ray, generating poisonous photochemical smog, which has a special odor, irritates eyes, harm plants, and reduces the visibility of the ambient air. Moreover, nitrogen oxides are capable of reacting with water in the air to form nitric acid and nitrous acid, which are the constituents of acid rain. Hydrocarbons can irritate the respiratory system even at lower concentration and will affect the central nervous system at higher concentration. Particulate matter can danger human health and can even cause cancer. In the light of above problems, how to control or inhibit the emission or content of noxious gases is an important issue.

In conventional technology, a U.S. Pat. No. 5,401,372 disclosed a device for the individual removal of nitrogen oxides, in which an electrochemical-catalytic reducing reaction is used in cooperation with a vanadium pentaoxide (V₂O₅) catalyst to convert nitrogen oxides into nitrogen. However, an additional electric source is required in the above device to power an electrochemical cell in this device. Therefore, not only energy is consumed, but also the object of eliminating a variety of noxious gases simultaneously is impossibly achieved.

Therefore, a U.S. Publ. No. 2013/0112552 disclosed an electro-catalytic tube for exhaust emissions control, which is capable of purifying a variety of pollutants without additional energy consumption and reducing gas. However, a half of channels must be sealed when the electro-catalytic tubes are stacked to be a honeycomb structural body desirably. In this way, not only reaction area is decreased, but also manufacturing cost is increased. Therefore, there is still room to improve in comparison with the existing automotive honeycomb catalytic converter.

Moreover, the above-mentioned problems are eliminated in a U.S. Pat. No. 9,028,764, which disclosed an electro-catalytic honeycomb for controlling exhaust emissions including a honeycomb structural body, a solid-oxide layer and a cathode layer. The honeycomb structural body includes an anode which is formed as a backbone of the honeycomb structural body, and a plurality of gas channels formed inside the backbone for passing the lean-burn exhaust. The solid-oxide layer is allowed to encapsulate the anode and has a tube wall facing the gas channels. The cathode layer is adhered to the tube wall. In this case, the anode has a reducing environment, and the cathode has an oxidizing environment. Thereby, the reducing environment and the oxidizing environment facilitate an electromotive force to occur between the anode and the cathode layer to promote a decomposition of nitrogen oxides of the lean-burn exhaust in the cathode layer.

However, in the fabrication of the electro-catalytic honeycomb of U.S. Pat. No. 9,028,764, it is difficult to reduce the anode to form the reducing environment because the cathode layer and the anode are exposed to an open space collectively, which is unfavorable to mass production for commercial fabrication.

### SUMMARY OF THE INVENTION

It is the main object of the present invention to solve the problem of disadvantageous mass production of the conventional electro-catalytic honeycomb for exhaust emissions control.

For achieving the above object, the present invention provides a method for manufacturing an electro-catalytic honeycomb for exhaust emissions control, comprising the steps of:

step 1: providing a honeycomb structural body, the honeycomb structural body including a backbone, a solid-oxide layer, a cathode layer and an inner annular layer, the backbone having an anode and a plurality of gas channels running through the anode, the anode being made of a first porous material, as well as the anode having an outer surface and an inner surface situated inside the gas channels, the solid-oxide layer being formed of a first dense structure and formed on the inner surface, as well as having a tube wall facing the gas channels, the cathode layer being made of a second porous material and adhered to the tube wall, the inner annular layer being formed of a second dense structure and encapsulating an annular end edge of the outer surface;

step 2: covering the inner annular layer by a sealing body in such a way that the gas channels of the honeycomb structural body are formed as an enclosed chamber, the sealing body including a hollow outer ring and a sealing membrane, a part of the hollow outer ring extending outwardly along an axial direction of the honeycomb structural body so as to be provided with an opening communicated with the gas channels after covering the inner annular layer, the sealing membrane sealing the opening;

step 3: reducing the anode to a reducing environment; and

step 4: covering the honeycomb structural body by an encapsulation and removing the sealing membrane of the sealing body for passing a lean-burn exhaust through the gas channels.

For achieving the above object, the present invention further provides an electro-catalytic honeycomb for exhaust emissions control, used for purifying a lean-burn exhaust, the electro-catalytic honeycomb including:

a honeycomb structural body, including:

a backbone, including an anode and a plurality of gas channels running through the anode for passing the lean-burn exhaust, the anode being made of a first porous material as well as the anode having an outer surface and an inner surface situated inside the gas channels;

a solid-oxide layer formed on the inner surface of the anode, the solid-oxide layer being formed of a first dense structure and having a tube wall facing the gas channels;

a cathode layer adhered to the tube wall, the solid-oxide layer being situated between the anode and the cathode layer, the cathode layer being made of a second porous material and having an oxidizing environment; and

an inner annular layer encapsulating an annular end edge of the outer surface, the inner annular layer being formed of a second dense structure; and

a sealing body provided over the inner annular layer.

In this case, the sealing body enables the gas channels of the honeycomb structural body to be formed as an enclosed chamber, such that the anode and the cathode layer are spaced apart from each other, so as to facilitate reduction of the anode to form a reducing environment.

In the present invention, in comparison with the prior art, the cathode layer and the exposed space of the anode are spaced apart from each other through the sealing body before the anode is reduced, so as to facilitate subsequent reducing step. Thus, the anode may be reduced sufficiently, while the cathode layer may be not affected by the reducing gas used in the reducing step. Hence, the oxidizing environment and the reducing environment are maintained and formed sufficiently in the cathode layer and the anode so as to facilitate the production.

### BRIEF DESCRIPTION OF THE DRAWINGS

FIG. 1, FIGS. 2A to 2B, FIG. 3, FIGS. 4A to 4B, FIG. 5, FIG. 6, FIG. 7, FIG. 8, and FIGS. 9A to 9B are diagrams illustrating manufacturing process of one embodiment of the present invention.

### DETAILED DESCRIPTION OF THE PREFERRED EMBODIMENTS

The technical contents of the present invention are described in detail in cooperation with drawings below.

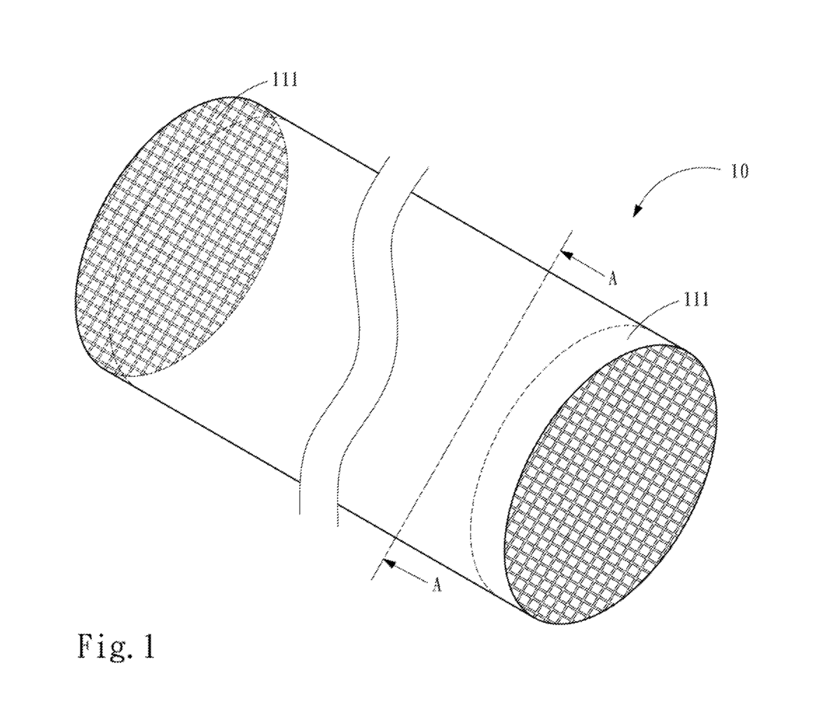

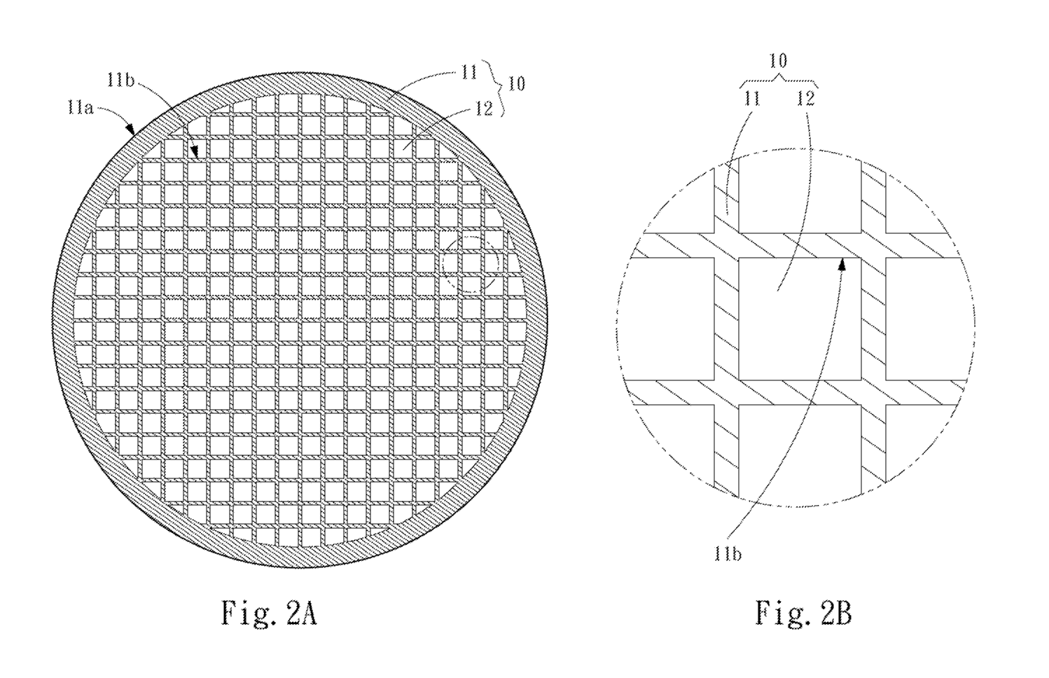

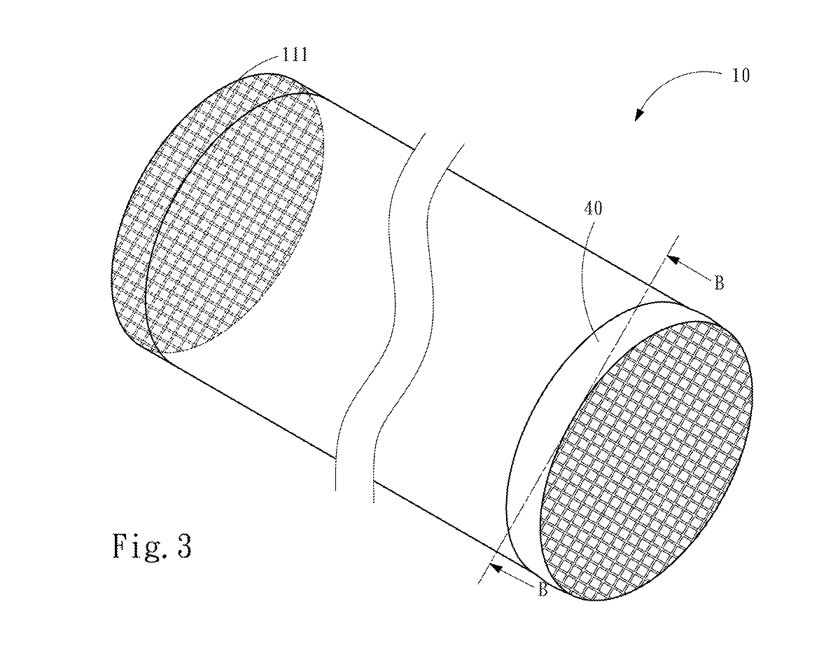

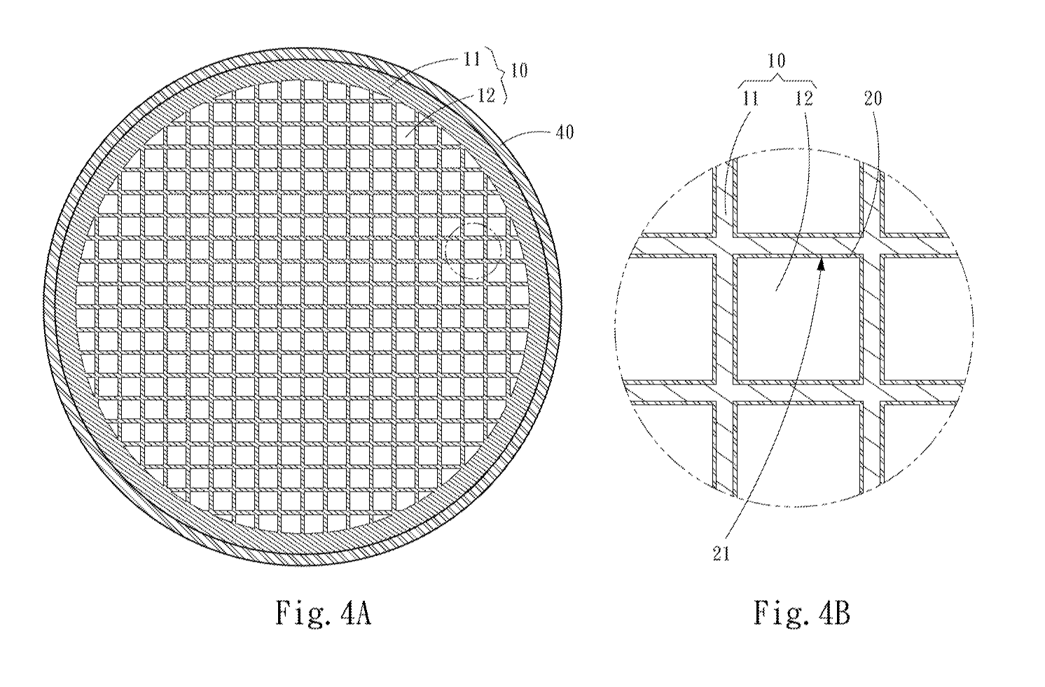

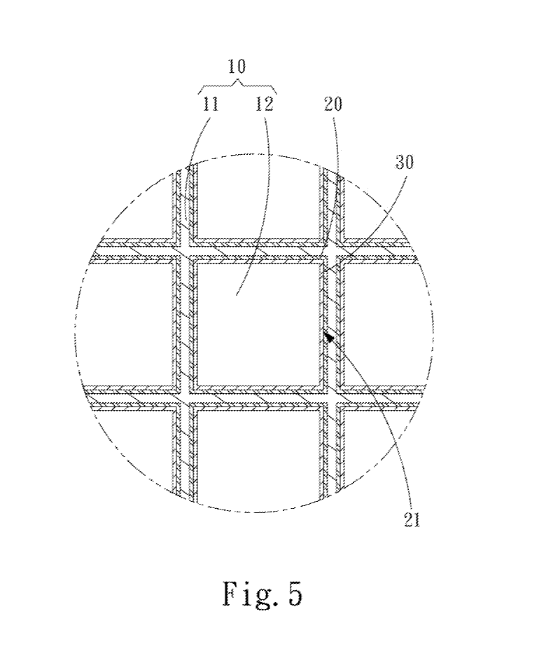

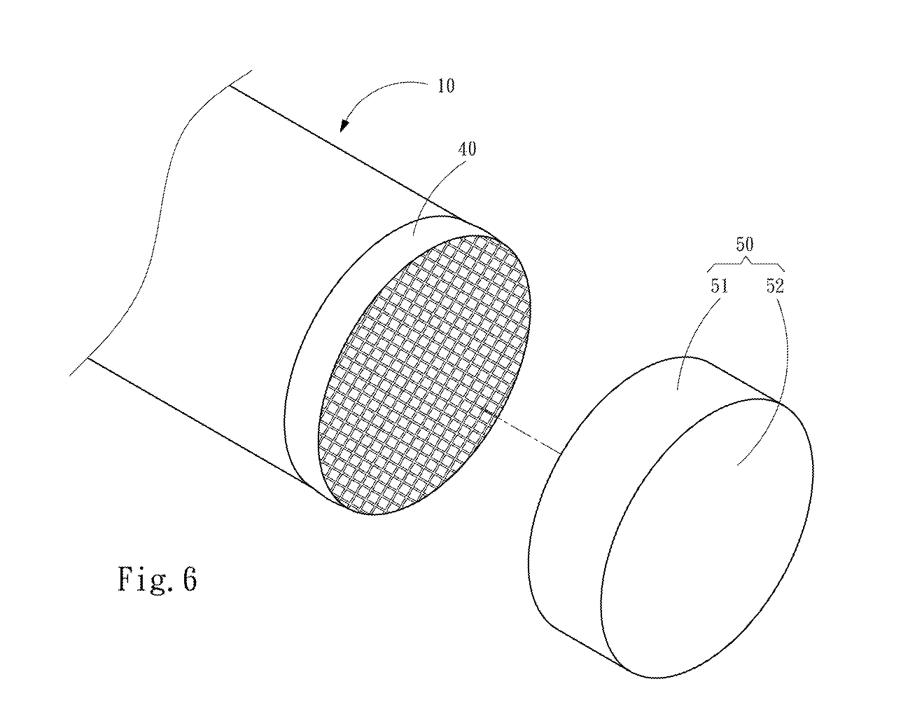

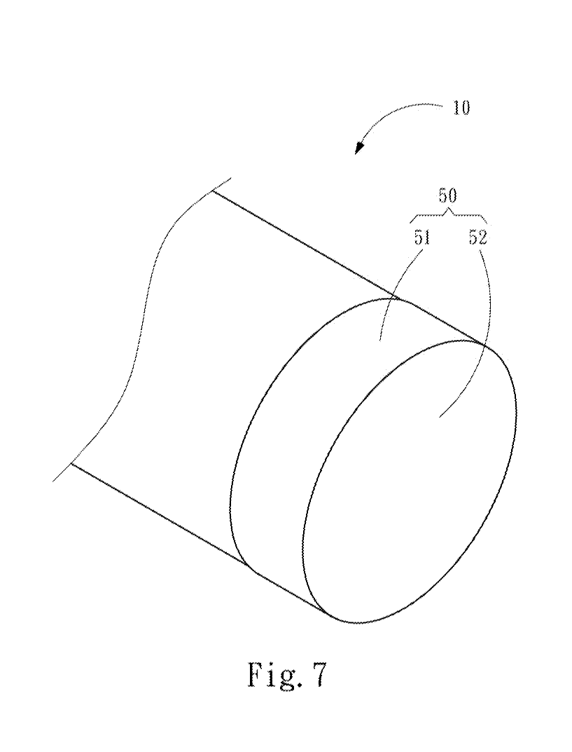

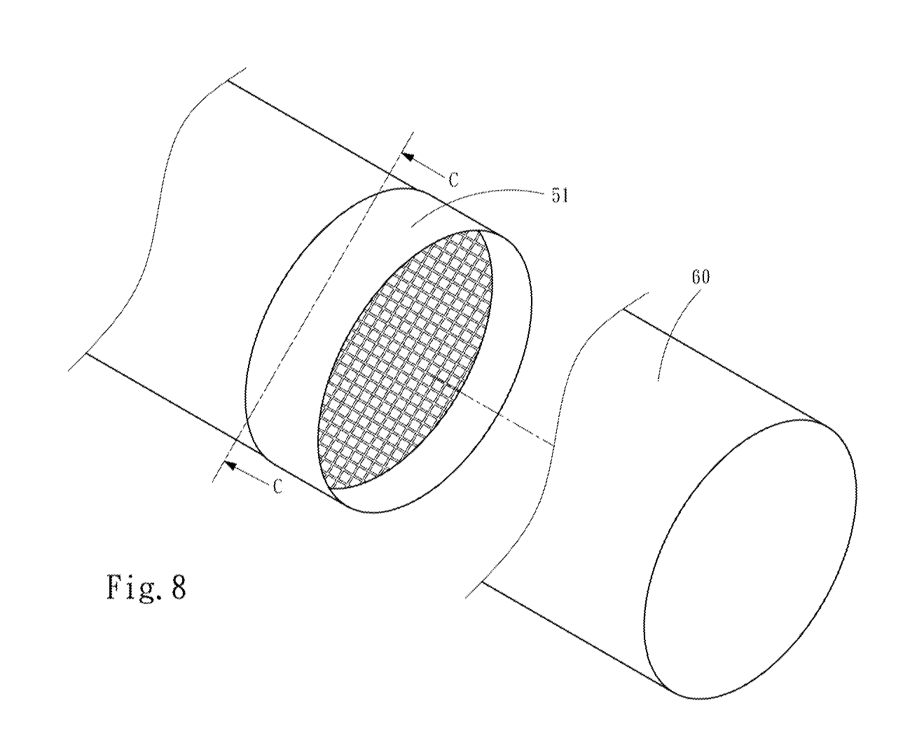

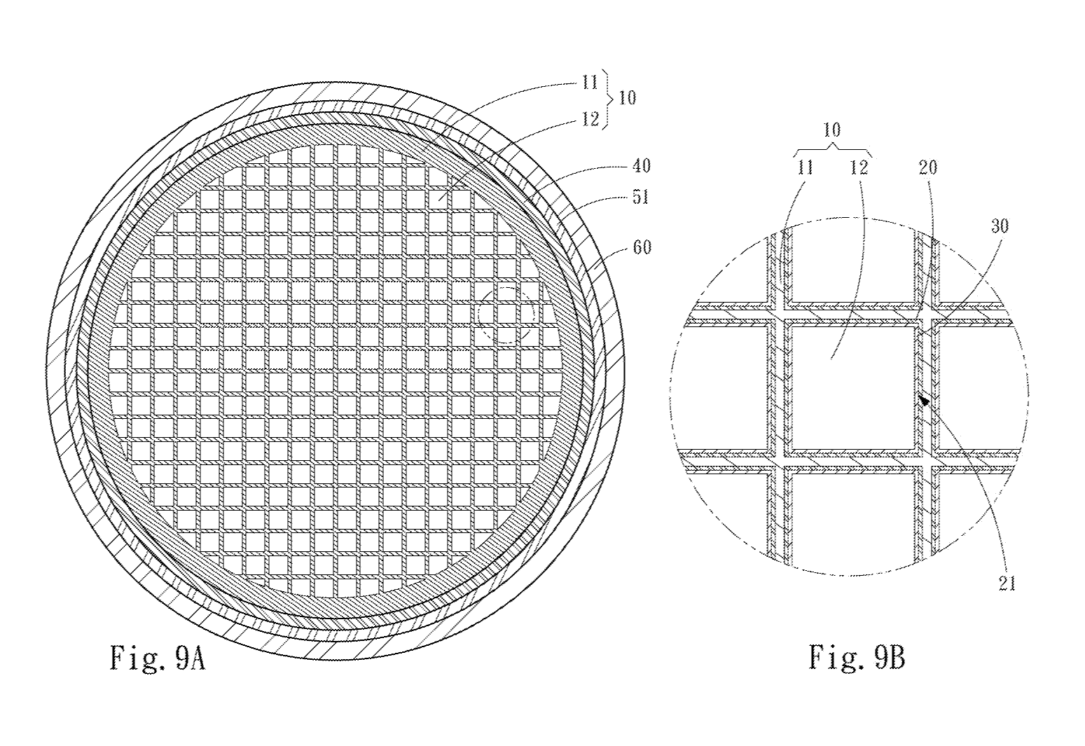

Referring to FIG. 1, FIGS. 2A to 2B, FIG. 3, FIGS. 4A to 4B, FIG. 5, FIG. 6, FIG. 7, FIG. 8, and FIGS. 9A to 9B, there are shown diagrams illustrating a manufacturing process of one embodiment of the present invention. The present invention provides a manufacturing method of an electro-catalytic honeycomb for exhaust emissions control, comprising the steps as follows.

In step 1, a honeycomb structural body is provided. In this embodiment, the production of the honeycomb structural body further comprises the steps as follows.

In step 1-1, referring to FIGS. 1, 2A and 2B, in which a perspective structural view of a backbone, a sectional view along A-A in FIG. 1, and a partially enlarged view of FIG. 2A of one embodiment of the present invention are schematically shown, respectively, a backbone 10 is provided. The backbone 10 comprises an anode 11, and a plurality of gas channels 12 running through two opposing ends of the anode 11. The anode 11 is provided with an outer surface 11a and an inner surface 11b situated inside the gas channels 12. The anode 11 is made of a first porous material, which may be a cermet composed of a metal and a fluorite metal oxide, a fluorite metal oxide, a perovskite metal oxide, a metal-added fluorite metal oxide or a metal-added perovskite metal oxide, such as a cermet composed of nickel and YSZ (Yttria-Stabilized Zirconia).

In step 1-2, referring to FIGS. 3, 4A and 4B, in which a perspective structural view of the backbone 10 after a solid-oxide layer 20 is formed, a sectional view along B-B in FIG. 3, and a partially enlarged view of FIG. 4A of one embodiment of the present invention are schematically shown, respectively, the formation of a solid-oxide layer 20 in this step comprises the formation on the inner surface 11b of the anode 11, and a part of one end face of each of two opposing ends of the anode 11 so as to encapsulate surfaces of opposing outer surfaces 11a of the anode 11 completely. The solid-oxide layer 20 is provided with a tube wall 21 facing the gas channels 12. The solid-oxide layer 20 is formed of a first dense structure having oxygen ion conductivity. In this embodiment, a solid oxide may be formed on the inner surface 11b and a part of the outer surface 11a of the anode 11 due to the consideration of production, the latter being an annular end edge 111 of the outer surface 11a. The solid oxide is allowed for forming the solid-oxide layer 20 on the inner surface 11b of the anode 11 and a part of the end face of each of two opposing ends of the anode 11, while forming an inner annular layer 40 on a part of the outer surface 11a, the inner annular layer 40 encapsulating the annular end edge 111 of the outer surface 11a of the anode 11. The inner annular layer 40 is formed of a second dense structure. The material of the solid oxide may be a fluorite metal oxide or a perovskite metal oxide, such as a fluorite Yttria-Stabilized Zirconia (YSZ), stabilized zirconia, fluorite Gadolinia-Doped Ceria (GDC), doped ceria, perovskite Lanthanum-Strontium-Gallium-Magnesium oxide (LSGM), doped lanthanum gallate. For instance, the slurry of the solid oxide is coated on the annular end edge 111 of the outer surface 11a, the end face and the inner surface 11b, and then sintered together so as to encapsulate annular end edge 111 of the outer surface 11a of the anode 11 and the inner part thereof. The foregoing are only exemplary, and the present invention is not limited thereto. In another embodiment, the inner annular layer 40 may be also formed of material different from that of the solid-oxide layer 20, or may be formed in another way.

In step 1-3, referring to FIG. 5, a cathode layer 30 is formed on the tube wall 21 and made of a second porous material, such as a perovskite metal oxide, a fluorite metal oxide, a metal-added perovskite metal oxide, or a metal-added fluorite metal oxide, such as a perovskite lanthanum-strontium-cobalt-copper oxide, a lanthanum-strontium-manganese-copper oxide, a combination of lanthanum-strontium-cobalt-copper oxide and GDC, a combination of lanthanum-strontium-manganese-copper oxide and GDC, a silver-added lanthanum-strontium-cobalt-copper oxide, a silver-added lanthanum-strontium-manganese-copper oxide, a combination of silver-added lanthanum-strontium-cobalt-copper oxide and GDC, and a combination of silver-added lanthanum-strontium-manganese-copper oxide and GDC.

In step 2, referring to FIGS. 6 and 7, a sealing body 50 is provided over the inner annular layer 40. In the present invention, the sealing body 50 comprises a hollow outer ring 51 and a sealing membrane 52. After covering the inner annular layer 40, a part of the hollow outer ring 51 is extended outwardly along an axial direction of the honeycomb structural body so as to be provided with an opening communicated with the gas channels 12. The sealing body 50 is sealingly joined to the inner annular layer 40 so as to seal the opening. In terms of this embodiment, a first sealingly joining layer, which is formed of a third dense structure, may be formed on the inner annular layer 40 firstly, and the sealing body 50 is then formed on the first sealingly joining layer, in such a way that the gas channels 12 of the honeycomb structural body may be formed as an enclosed chamber. The materials of the hollow outer ring 51, the sealing membrane 52 and the first sealingly joining layer may be all metals, alloys, glasses or ceramics. Alternatively, it is also possible to firstly form the hollow outer ring 51 on the first sealingly joining layer, and then form the sealing membrane 52 on an outer edge of the hollow outer ring 51 so as to seal the opening. In this connection, the first sealingly joining layer is used to facilitate the junction between the hollow outer ring 51 and the inner annular layer 40, in such a way that the gas channels 12 of the honeycomb structural body may be formed as an enclosed chamber, i.e., the cathode layer 30 and the exposed space of the outer surface 11a of the anode 11 are spaced apart from each other.

In step 3, the anode 11 is reduced to a reducing environment. In one embodiment of the present invention, the cathode layer 30 is exposed to air before the gas channels 12 of the honeycomb structural body are sealed, and oxidized to an oxidizing environment in the process of sintering in air. The exposed space of the outer surface 11a of the anode 11 should be larger for beneficial to reduce the anode 11 to the reducing environment. Thus, sufficient contact with a reducing gas and then sooner reduction of the anode 11 are obtained. Therefore, the narrower the annular end edge 111 of the outer surface 11a encapsulated by the inner annular layer 40 is, the better it is. Moreover, it is sufficient for the annular end edge 111 to be covered by the hollow outer ring 51 of the sealing body 50. In this embodiment, the anode 11 includes a metal oxide, which may be reduced to a metal by treatment using the reducing gas, such as reducing nickel oxide to nickel. Also, the metal oxide may be reduced to an oxygen-deficient metal oxide, so as to form the reducing environment of the anode 11. Additionally, before the anode 11 is sealed in step 4, carbon monoxide or hydrocarbons may be previously added to the anode 11, such as methane, ethane, propylene or propane being introduced into the anode 11 through pore diffusion, to form a carbon species adhered to the pores of the anode 11, such that the reducing environment of the anode 11 is enhanced. In addition, the gas inside the pores of the anode 11 may be extracted to form a sub-atmospheric pressure or vacuum before the anode 11 is sealed in step 4, whereby the honeycomb structural body is exempted from the structural damage caused by thermally-induced expansion and contraction during the treatment of the exhaust.

In step 4, referring to FIGS. 8, 9A and 9B, in which a perspective structural view of the backbone 10 covered by an encapsulation 60 with the sealing membrane 52 being removed, a sectional view along C-C in FIG. 8, and a partially enlarged view of FIG. 9A of one embodiment of the present invention are schematically shown, respectively. In this step, the sealing membrane 52 of the sealing body 50 is removed with the encapsulation 60 covering the honeycomb structural body. The encapsulation 60 is provided over the hollow outer ring 51 to seal the outer surface 11a of the anode 11, and then isolate the anode 11 from being contacted with air. Thus, the reducing environment of the anode 11 is maintained. In this embodiment, a second sealingly joining layer, which is formed of a fourth dense structure, is formed on the hollow outer ring 51 before the encapsulation 60 is provided, and the encapsulation 60 is then formed on the second sealingly joining layer. The material of the second sealingly joining layer, preferably featuring thermal softening, may be metals, alloys, glasses, ceramics or the combination thereof such as silver, silver-tin alloys, silver-copper-tin alloys or copper-tin alloys, for example, so as to eliminate the problem of thermal stress occurring at high-low alternating temperature during operation on account of the difference between coefficients of thermal expansion of the encapsulation 60 and the honeycomb structural body.

The encapsulation 60 can be implemented through a variety of aspects in the present invention. For example, in an embodiment, the encapsulation 60 may be a shell made of protective materials as metals and house the honeycomb structural body; alternatively, in another embodiment, the encapsulation 60 may be a layer made of sodium silicate glasses and cover the honeycomb structural body; alternatively, in other embodiment, the encapsulation 60 may comprise an encapsulating layer and an encapsulating shell, in which the encapsulating layer made of sodium silicate glasses to fill up a space between the honeycomb structural body and the encapsulating shell, while the encapsulating shell served as a housing, and provided over the honeycomb structural body as well as the encapsulating layer. In this case, the encapsulating layer being formed of a fifth dense structure to seal the outer surface of the honeycomb structural body and also increase a shock resistance of the electro-catalytic honeycomb. Therefore, depending on the usage of the encapsulation 60, the material of the encapsulation 60 may be selected from metals, alloys, glasses or ceramics, but the invention is not limited thereto. To sum up, the cathode layer and the exposed space of the anode are spaced apart from each other through the sealing body before the anode is reduced, so as to facilitate subsequent reducing step. Thus, the anode may be reduced sufficiently, while the cathode layer may be not affected by the reducing gas. Hence, the oxidizing environment and the reducing environment are maintained and formed sufficiently in the cathode layer and the anode so as to facilitate the production.

What is claimed is:

1. A manufacturing method of an electro-catalytic honeycomb for exhaust emissions control, comprising the steps of:
step 1: providing a honeycomb structural body, the honeycomb structural body including a backbone, a solid-oxide layer, a cathode layer and an inner annular layer, the backbone having an anode and a plurality of gas channels running through the anode, the anode being made of a first porous material, as well as the anode having an outer surface and an inner surface situated inside the gas channels, the solid-oxide layer being formed of a first dense structure and formed on the inner surface, as well as having a tube wall facing the gas channels, the cathode layer being made of a second porous material and adhered to the tube wall, the inner annular layer being formed of a second dense structure and encapsulating an annular end edge of the outer surface;
step 2: covering the inner annular layer by a sealing body in such a way that the gas channels of the honeycomb structural body are formed as an enclosed chamber, the sealing body including a hollow outer ring and a sealing membrane, a part of the hollow outer ring extending outwardly along an axial direction of the honeycomb structural body so as to be provided with an opening communicated with the gas channels after covering the inner annular layer, the sealing membrane sealing the opening;
step 3: reducing the anode to a reducing environment; and
step 4: covering the honeycomb structural body by an encapsulation so as to seal the outer surface and removing the sealing membrane of the sealing body for passing a lean-burn exhaust through the gas channels.

2. The manufacturing method according to claim 1, wherein step 1 comprising the steps of:
step 1-1: providing the backbone firstly;
step 1-2: forming a solid oxide on the annular end edge of the outer surface and the inner surface of the anode, so as to form the inner annular layer on the outer surface and the solid-oxide layer on the inner surface, the inner annular layer encapsulating the annular end edge; and
step 1-3: forming the cathode layer on the tube wall.

3. The manufacturing method according to claim 1, wherein a first sealingly joining layer is formed on the inner annular layer firstly, and the sealing body is then formed on the first sealingly joining layer, the first sealingly joining layer being formed of a third dense structure.

4. The manufacturing method according to claim 3, wherein in step 2, the hollow outer ring is formed on the first sealingly joining layer firstly, and the sealing membrane of the sealing body is then connected to an outer edge of the hollow outer ring so as to seal the opening of the hollow outer ring.

5. The manufacturing method according to claim 1, wherein a second sealingly joining layer is formed on the hollow outer ring before the encapsulation is provided, and the encapsulation is then provided over the honeycomb structural body to seal the outer surface, the second sealingly joining layer being formed of a fourth dense structure.

6. The manufacturing method according to claim 1, wherein the encapsulation comprises an encapsulating layer and an encapsulating shell, the encapsulating layer formed on the outer surface of the honeycomb structural body, and the encapsulating shell then provided over the honeycomb structural body as well as the encapsulating layer, the encapsulating layer being formed of a fifth dense structure and filled up a space between the honeycomb structural body and the encapsulating shell to seal the outer surface.

7. An electro-catalytic honeycomb for exhaust emissions control, used for purifying a lean-burn exhaust, the electro-catalytic honeycomb including:
a honeycomb structural body, including:
a backbone, having an anode and a plurality of gas channels running through the anode for passing the lean-burn exhaust, the anode being made of a first porous material as well as the anode having an outer surface and an inner surface situated inside the gas channels;
a solid-oxide layer formed on the inner surface of the anode, the solid-oxide layer being formed of a first dense structure and having a tube wall facing the gas channels;
a cathode layer adhered to the tube wall, the solid-oxide layer being situated between the anode and the cathode layer, the cathode layer being made of a second porous material and having an oxidising environment; and
an inner annular layer encapsulating an annular end edge of the outer surface, the inner annular layer being formed of a second dense structure; and
a sealing body provided over the inner annular layer,
wherein the sealing body enables the gas channels of the honeycomb structural body to be formed as an enclosed chamber, such that the anode and the cathode layer are spaced apart from each other, so as to facilitate reduction of the anode to form a reducing environment.

8. The electro-catalytic honeycomb according to claim 7, wherein the sealing body further comprising a hollow outer ring and a sealing membrane, a part of the hollow outer ring extending outwardly along an axial direction of the honeycomb structural body so as to be provided with an opening communicated with the gas channels after covering the inner annular layer.

9. The electro-catalytic honeycomb according to claim 8, further comprising a first sealingly joining layer formed between the inner annular layer and the hollow outer ring, the first sealingly joining layer being formed of a third dense structure.

10. The electro-catalytic honeycomb according to claim 8, further comprising a second sealingly joining layer formed on the hollow outer ring and an encapsulation connected to the second sealingly joining layer so as to cover the honeycomb structural body, the second sealingly joining layer being formed of a fourth dense structure, the encapsulation sealing the outer surface.

11. The electro-catalytic honeycomb according to claim 8, further comprising an encapsulating layer and an encapsulating shell, the encapsulating layer formed on the outer surface of the honeycomb structural body, and the encapsulating shell then provided over the honeycomb structural body as well as the encapsulating layer, the encapsulating layer being formed of a fifth dense structure and filled up a space between the honeycomb structural body and the encapsulating shell to seal the outer surface.
